(19) United States
(12) Patent Application Publication
(10) Pub. No.: US 2005/0117555 A1
(43) Pub. Date: Jun. 2, 2005

(54) Device and method for auto-switching wireless network

(76) Inventor: Zhi-Heng Nian, San Chong (TW)

Correspondence Address: Raymond Sun, Suite 155, 20 Corporate Park, Irvine, CA, 92606, US

(21) Appl. No.: 10/796,469

(22) Filed: Mar. 8, 2004

(30) Foreign Application Priority Data
Dec. 2, 2003 (TW) 92133928

(51) Int. Cl. H04Q 7/24

(52) U.S. Cl. 370/338

(57) ABSTRACT

A communicating system for establishing a wireless communication between a computer and a wireless peripheral device includes a wireless peripheral device, a computer, and a wireless network coupling the peripheral device and the computer. The computer has a wireless network card within the computer, the wireless network card having a detection module which sends a data packet with identification via the wireless network to search for the wireless peripheral device. The peripheral device then sends an acceptable feedback signal based on the identification to the detection module so as to establish a wireless communication.

### BACKGROUND OF THE INVENTION

1. Field of the Invention

The present invention relates to wireless network communication, and in particular, to an auto-switching method and device for establishing a communication link between a computer and a wireless peripheral device.

2. Description of the Related Art

There are two different ways to transmit data or communicate through a network environment. The first way is a wired communication with a cable, and the second way is a wireless communication with an infrared ray, radio frequency or the like. However, due to the convenience in installation and its mobility in use, wireless communication is becoming increasingly popular.

The wireless network can be further classified according to its range of data transmission. Examples include a wireless wide area network (WWAN), a wireless local area network (WLAN), and a wireless personal area network (WPAN). The WLAN is a network which can be transmitted in a range of about hundred meters, and is usually applied in a single building or in an office. In practical use, the WLAN will adopt an Access Point to combine with a wired network so as to promote flexibility in use and to enlarge the transmission range. WLAN protocol is now governed by the Institute of Electrical and Electronic Engineers (IEEE), which essentially introduces several wireless communication protocol standards, such as 802.11 serial, HIPERLAN, HOMERF and 1394, etc. Ad-hoc mode and Infrastucture mode are further defined in 802.11 serial. The ad-hoc mode discloses a peer-to-peer (computer to computer, or computer to device) wireless communication, and the infrastructure mode discloses a wireless communication between a wired network and a wireless network via an Access Point.

However, the conventional computer peripheral devices typically use radio frequency (RF) to control the operation of a computer system, where each different brand name product has its own different communication protocol for communicating with its own related products. Therefore, it has become more important to allow computer peripheral devices to be incorporated with the prevalent wireless network.

Nowadays, a wireless communication between a computer and a peripheral device uses a user assignment mode or auto-searching mode to achieve a link. It is easier to find a network in the auto-searching mode, but this mode can fail to find a proper network when the network has more than one peripheral device since the computer may be led to wrongly connect to an unexpected peripheral device, thereby causing a security problem. In contrast, the user assignment mode is a safe and direct way to achieve the link, but a user interface is needed for a user to assign a network, and the user has to be familiar with, or recognize, a correct network from a plurality of peripheral devices.

### SUMMARY OF THE INVENTION

It is an object of the present invention to provide an efficient method and device to establish a wireless communication link between a computer and at least one peripheral device.

The objectives of the present invention can be accomplished by providing a communicating system for establishing a wireless communication between a computer and a wireless peripheral device. The system includes at least one wireless peripheral device, a computer, and a wireless network coupling the peripheral device and the computer. The computer has a wireless network card within the computer, the wireless network card having a detection module which sends a data packet with identification via the wireless network to search for the wireless peripheral device. The peripheral device then sends an acceptable feedback signal based on the identification to the detection module so as to establish a wireless communication. The wireless communication can be based on a standard wireless network communication protocol.

### BRIEF DESCRIPTION OF THE DRAWINGS

FIG. 1 is a block diagram of a communication system according to the present invention.

FIG. 2 is a block diagram showing a detection module within a wireless network card in the system of FIG. 1.

FIG. 3 is a flow chart diagram illustrating a communication method according to the present invention.

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

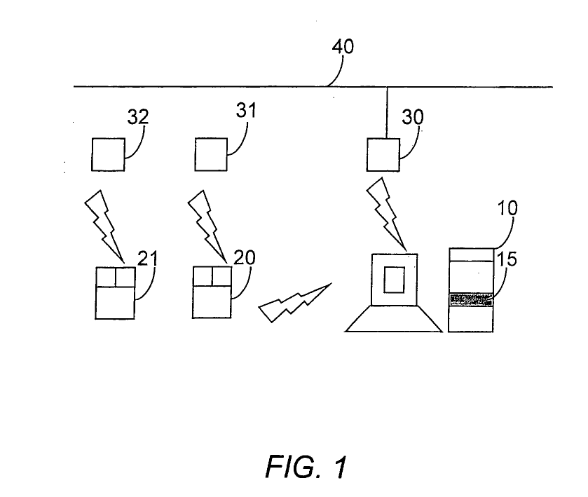

Referring to FIG. 1, a computer 10 establishes a wireless connection with a peripheral device 20 or 21, via a wired network 40. The wired network 40 can communicate with the peripheral device 21 and 20 via access points 32 and 31, respectively. The computer 10 can also communicate with the wired network 40 via an access point 30. Although FIG. 1 illustrates two peripheral devices 20, 21, it is possible for the computer 10 to communicate with any number (e.g., one, two, three, and more) of peripheral devices.

The computer 10 has a wireless network card 15 which complies with a standard wireless network communication protocol, such as but not limited to the 802.11 serial protocol standard enacted by the IEEE. In addition, each peripheral device 20, 21 can be a computer mouse, trackball, keyboard, joystick, tablet, touch pad, game controller, scanner, printer, or similar devices. Furthermore, the card 15 can support the usage of an ad-hoc mode and an infrastructure mode. Ad-hoc mode and infrastucture mode are further defined in the 802.11 serial protocol.

Here, the peripheral devices 20 and 21 can represent two different networks. The wired network 40 can be wired to the access point 30, and then wirelessly connected to the access points 31 and 32 based on an infrastructure mode. Meanwhile, the computer 10 can also communicate directly with the peripheral devices 20 and 21 using an ad-hoc mode.

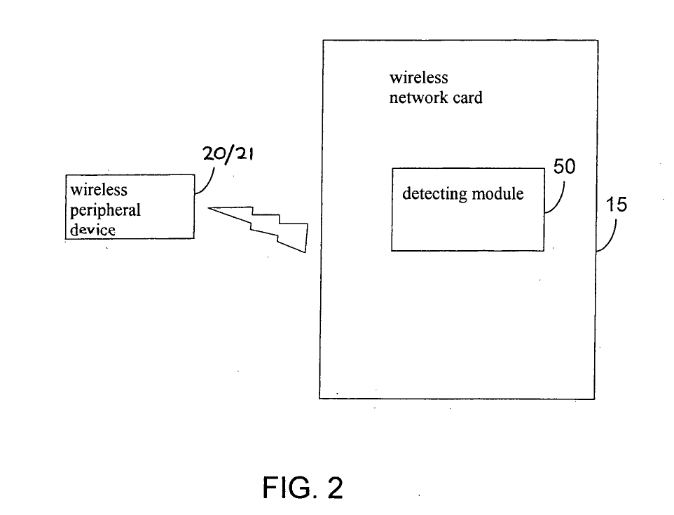

Referring to FIG. 2, the wireless network card 15 has a detection module 50 that establishes a wireless connection with a wireless peripheral device 20 or 21. The detection module 50 can search for a plurality of wireless peripheral devices, including peripheral devices 20, 21 and other peripheral devices.

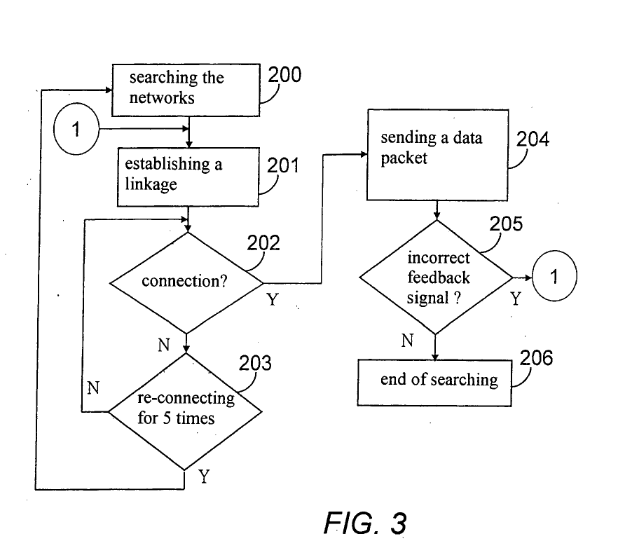

FIG. 3 is a flowchart that illustrates the operation of the system in FIG. 1. If the computer 10 needs to communicate with the wireless peripheral device 21 shown in FIG. 1, the detection module 50 of the network card 15 will search the existing networks (step 200) to try to establish a linkage or connection (step 201) with the peripheral device 21. To do this, the network card 15 will send a wireless signal to all the peripheral devices, which include 20 and 21. In step 202, it is determined whether a connection or linkage with a particular peripheral device (which can be either 20 or 21) is successful. The connection can fail because of any number of reasons, including but not limited to, interference in the wireless transmission. If the connection fails, then in step 203, the detection module 50 will continue trying to establish a connection with a peripheral device for a predetermined period of time (for example, 5 times). If the detection module 50 still cannot establish a connection after this period of time, then processing proceeds to step 200 where the detection module 50 will switch to another peripheral device.

On the other hand, if the connection to a peripheral device is established in step 202, then in step 204, the detection module 50 will send a data packet with identification to the connected peripheral device.

At this time, step 205 determines whether the detection module 50 receives a correct or incorrect feedback signal from the connected peripheral device. In the present example, the detection module 50 wishes to connect with the peripheral device 21, so an incorrect feedback signal will be received by the detection module 50 from the peripheral device 20. Conversely, a correct feedback signal will be received by the detection module 50 from the peripheral device 21.

Thus, if the detection module 50 receives an incorrect feedback signal from the peripheral device 20 in step 205, then processing proceeds to step 201 where the detection module 50 will switch to another peripheral device to try to establish a linkage or connection with this other peripheral device.

On the other hand, if the detection module 50 receives a correct feedback signal from the peripheral device 21 in step 205, then processing continues to step 206 where the detection module 50 will end the searching.

According to the present invention, if the system has only one peripheral device (e.g., 21), then the detection module 50 will always successfully establish a linkage so that an incorrect feedback signal should never be received in step 205.

Therefore, the peripheral device 21 can control the operation of the computer 10 via a wireless network. In other words, the peripheral device 21 will send a command to the wired network 40 via the closest access point 32, and the card 15 will receive a command that complies with a standard wireless network communication protocol, so as to operate the computer 10. The peripheral device 20 can find another compatible computer to be connected to, using the method described above.

In accordance with another embodiment, the peripheral device 20, 21 can be a remote-controlled device, and the wireless network card 15 can be built into a house appliance, such as a refrigerator, air conditioner, television, etc.

However, the computer 10 can possibly communicate with a plurality of peripheral devices 20, 21 when playing a game, and a plurality of peripheral devices 20, 21 can communicate with a corresponding computer 10 through a wireless or a wired network. Thus, each user of each separate peripheral device 20, 21 can operate his or her own game controller to play an online game.

While the description above refers to particular embodiments of the present invention, it will be understood that many modifications may be made without departing from the spirit thereof.

1. A communicating system for establishing a wireless communication between a computer and a wireless peripheral device, comprising:
a wireless peripheral device;
a computer;
a wireless network coupling the peripheral device and the computer;
wherein the computer has a wireless network card within the computer, the wireless network card having a detection module which sends a data packet with identification via the wireless network to search for the wireless peripheral device;
wherein the peripheral device sends an acceptable feedback signal based on the identification to the detection module so as to establish a wireless communication; and
wherein the wireless communication is based on a standard wireless network communication protocol.

2. The assembly as claimed in claim 1, wherein the wireless peripheral device is selected from the group consisting of a wireless input device, a wireless output device and a wireless input and output device.

3. The assembly as claimed in claim 2, wherein the input device is selected from the group consisting of a computer mouse, a keyboard, a trackball, a joystick, and a game controller.

4. The assembly as claimed in claim 2, wherein the output device is selected from the group consisting of a computer mouse, a card reader/writer, a digital camera, and a printer.

5. The assembly as claimed in claim 2, wherein the input and output device is selected from the group consisting of a mouse, a joystick, and a game controller.

6. The assembly as claimed in claim 1, wherein the computer is built into a house appliance, and the peripheral device is a remote controlled device.

7. The assembly as claimed in claim 1, wherein the standard wireless network communication protocol is enacted by the IEEE.

8. The assembly as claimed in claim 1, wherein the wireless communication is based on an ad-hoc mode.

9. The assembly as claimed in claim 1, wherein the wireless communication is based on an infrastructure mode.

10. The assembly as claimed in claim 1, wherein the wireless peripheral device comprises at least two wireless peripheral devices, wherein only the desired peripheral device sends an acceptable feedback signal based on the identification to the detection module so as to establish a wireless communication, with the other peripheral devices sending an unacceptable feedback signal.

11. A method for establishing a wireless communication between a computer and a wireless peripheral device, the computer having a wireless network card which has a detection module therein, the method comprising:
sending from the detection module a data packet with identification via a wireless network to the peripheral device, with the identification used to search for the peripheral device;
receiving an acceptable feedback signal from the peripheral device based on the identification so as to establish the wireless communication; and
wherein the wireless communication is based on a standard wireless network communication protocol.

12. A method for establishing a wireless communication between a computer and a plurality of wireless peripheral devices, comprising the steps:
sending a data packet with identification from the computer to one of the peripheral devices;
receiving at the computer an acceptable feedback signal from a desired peripheral device that is used to establish the wireless communication, while receiving at the computer an unacceptable feedback signal from the other peripheral devices; and
wherein the wireless communication is based on a standard wireless network communication protocol.
